(19) United States
(12) Patent Application Publication
(10) Pub. No.: US 2008/0162235 A1
(43) Pub. Date: Jul. 3, 2008

(54) Method and Means for Optimizing Maintenance Work Schedules

(75) Inventors: Robert N. Tomastik, Rocky Hill, CT (US); Jihua Wang, Unionville, CT (US); Howard A. Winston, Woodbury, CT (US); Julie A. Ireland, East Hampton, CT (US); Beth K. Matonak, East Hartford, CT (US); David J. Sirag, Ellington, CT (US)

Correspondence Address: BACHMAN & LAPOINTE, P.C. (P&W), 900 CHAPEL STREET, SUITE 1201, NEW HAVEN, CT, 06510-2802, US

(73) Assignee: UNITED TECHNOLOGIES CORPORATION, Hartford, CT (US)

(21) Appl. No.: 11/618,802

(22) Filed: Dec. 30, 2006

(51) Int. Cl. G06F 9/46

(52) U.S. Cl. 705/8

(57) ABSTRACT

The optimization algorithm described herein combines stochastic programming and intelligent enumeration schemes that exploit the problem structure to avoid evaluating solutions that on their face are known to be non-optimal. The optimization algorithm finds the module workscope decisions and LLP replacement decisions that minimize expected future maintenance cost per engine flight cycle. The optimization algorithm considers the enormous number of possible solutions, and determines the best one.

### FIELD OF THE INVENTION

The invention relates to fleet management programs. More particularly, the invention relates to method and means for optimizing maintenance work schedules for fleet management programs.

### BACKGROUND OF THE INVENTION

An important aspect of cost-effectively executing a Fleet Management Program (hereinafter “FMP”) is determining what maintenance work to perform when an engine is taken off wing and sent to a maintenance facility. Typically, an engine is sent for one of several reasons: repairing damage, restoring performance, replacing life-limited parts (hereinafter “LLP's”), that have reached their limit, and/or upgrading the engine for improved reliability.

After an engine arrives at the maintenance shop, the service manager(s) determine the “workscope” document, which specifies the repairs and replacements to be performed, including which LLP's to replace. LLP's are parts that have limited operating life, defined as having maximum number of allowable cycles, where a cycle is throttling up and down of the engine, such as a take-off and landing. By policy, an engine cannot be used when any one of its LLP's has met or exceeded its cycle limit. The workscope document also specifies what level of repair to perform for each module; for example, the workscope document might specify doing a “heavy” maintenance on the high pressure compressor and the high pressure turbine, and a “light” maintenance on the fan, low pressure compressor, and low pressure turbine.

The workscope and LLP replacement decisions play a critical role in the costs involved in any FMP, especially when one considers that the cost of one shop visit can exceed $1,000,000.00. These workscope and LLP replacement decisions are also quite complex. In a typical engine, there are 30 to 40 LLP's and 10 to 15 modules, each module having 3 to 5 different workscope levels. This results in a huge number of possible combinations. A service manager can only be expected to consider a handful of possible solutions, and even then may not find or select, for that matter, the best solution.

Therefore, there exists a need to predict future expected engine cycles between shop visits, and address the impact of today's decisions on the expected cost(s) of the next shop visit.

There also exists a need to utilize this prediction to optimize maintenance cost per engine flight cycle over two shop visits, that is, the current shop visit and the next shop visit.

There also exists a need to consider the probability of unscheduled engine removals.

### SUMMARY OF THE INVENTION

In accordance with one aspect of the present invention, a process for optimizing maintenance work schedules in a fleet management program for at least one engine broadly comprises creating at least one possible LLP workscope decision for a first shop visit for at least one engine; creating at least one unscheduled engine repair scenario for each of the at least one possible LLP workscope decision for the first shop visit; selecting one of the at least one unscheduled engine repair scenario for one of the at least one possible LLP workscope decision for the first shop visit; calculating at least one expected cost for the one of the unscheduled engine repair scenario for the first shop visit; determining a lowest expected cost of the at least one expected cost for the one of the unscheduled engine repair scenario for the first shop visit; associating the lowest expected cost with at least one of the at least one possible LLP workscope decisions for the first shop visit; selecting an LLP workscope decision out of the at least one possible LLP workscope decision based upon the association with the lowest expected cost for the first shop visit; and performing upon the at least one engine the LLP workscope decision having the lowest expected cost.

In accordance with another aspect of the present invention, a process for optimizing maintenance work schedules in a fleet management program for at least one engine broadly comprises creating at least one possible LLP workscope decision for a first shop visit for at least one engine; creating at least one unscheduled engine repair scenario for each of the at least one possible LLP workscope decision for the at least one engine; evaluating the at least one unscheduled repair scenario according to an equation

$${\sum }_{n = 1}^{N} {P}_{n} \times E [ \frac{C 1 + C 2 * ( n )}{CBSV 1 ( n ) + CB \tilde{S} V 2 * ( n )} ]$$

wherein n=1,2,3 . . . ; N includes the at least one unscheduled engine repair scenario; C1 comprises an expected cost of the first shop visit for the at least one possible LLP workscope decision; C2 comprises an optimal cost for an unscheduled repair scenario n; Pₙ comprises the probability of scenario n; CBSV1(n) includes at least one cycle for the unscheduled engine repair scenario n; CBSV2*(n) includes at least one cycle for a possible LLP workscope decision for the unscheduled repair scenario n; and, ˜ comprises a random variable; selecting one of the at least one unscheduled engine repair scenario for one of the at least one possible LLP workscope decision for the first shop visit; calculating at least one expected cost for the one of the unscheduled engine repair scenario for the first shop visit; enumerating at least one possible solution for the one of the unscheduled engine repair scenario, the at least one possible solution comprising at least one optimal LLP workscope decision or at least one non-optimal LLP workscope decision; applying at least one of four insights to identify the at least one non- optimal LLP workscope decision out of the at least one possible solution; identifying out of the at least one possible solution a non-optimal solution based upon the at least one of four insights, the non-optimal solution comprising at least one non- optimal LLP workscope decision; identifying out of the at least one possible solution an optimal solution based upon the at least one of four insights and associated with a lowest expected cost out of all of the at least one expected cost, the optimal solution comprising the at least one optimal LLP workscope decision having the lowest expected cost out of all of the at least one expected cost; and performing upon the at least one engine the at least one optimal LLP workscope decision having the lowest expected cost.

In accordance with yet another aspect of the present invention, a system broadly comprising a computer readable storage device readable by the system, tangibly embodying a program having a set of instructions executable by the system to perform the following steps for optimizing maintenance work schedules of a fleet management program for at least one engine, the set of instructions broadly comprising: an instruction to create at least one possible LLP workscope decision for a first shop visit for at least one engine; an instruction to create at least one unscheduled engine repair scenario for each of the at least one possible LLP workscope decision for the first shop visit; an instruction to select one of the at least one unscheduled engine repair scenario for one of the at least one possible workscope decision for the first shop visit; an instruction to calculate at least one expected cost for the one of the unscheduled engine repair scenario for the first shop visit; an instruction to determine a lowest expected cost of the at least one expected cost for the one of said unscheduled engine repair scenario for the first shop visit; an instruction to associate the lowest expected cost with at least one of the at least one possible LLP workscope decision for the first shop visit; an instruction to select an LLP workscope decision out of the at least one possible LLP workscope decision based upon the association with the lowest expected cost for the first shop visit; and an instruction to perform the LLP workscope decision having the lowest expected cost upon the at least one engine.

In accordance with yet another aspect of the present invention, a system broadly comprising a computer readable storage device readable by the system, tangibly embodying a program having a set of instructions executable by the system to perform the following steps for optimizing maintenance work schedules of a fleet management program for at least one engine, the set of instructions broadly comprising: an instruction to create at least one possible LLP workscope decision for a first shop visit for at least one engine; an instruction to create at least one unscheduled engine repair scenario for each of the at least one possible LLP workscope decision for at least one engine; an instruction to evaluate the at least one unscheduled repair scenario according to an equation

$${\sum }_{n = 1}^{N} {P}_{n} \times E [ \frac{C 1 + C 2 * ( n )}{CBSV 1 ( n ) + CB \tilde{S} V 2 * ( n )} ]$$

an instruction to select one of the at least one unscheduled engine repair scenario for one of the at least one possible LLP workscope decision for the first shop visit; an instruction to calculate at least one expected cost for the one of the unscheduled engine repair scenario for the first shop visit; an instruction to enumerate at least one possible solution for the one of the unscheduled engine repair scenario, the at least one possible solution comprising at least one optimal LLP workscope decision or at least one non-optimal LLP workscope decision; an instruction to apply at least one of four insights to identify the at least one non-optimal LLP workscope decision out of the at least one possible solution; an instruction to identify out of the at least one possible solution a non-optimal solution based upon the at least one of four insights, the non-optimal solution comprising at least one non-optimal LLP workscope decision; an instruction to identify out of the at least one possible solution an optimal solution based upon the at least one of four insights and associated with a lowest expected cost out of all of the at least one expected cost, the optimal solution, the optimal solution comprising the at least one optimal LLP workscope decision having a lowest expected cost of all of the at least one expected cost; and an instruction to perform the at least one optimal LLP workscope decision having the lowest expected cost upon the at least one engine.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a representation of a timeline of a maintenance schedule for an engine involving a first shop visit and a second shop visit;

FIG. 2 is a representation of module access dependencies within the engine represented in the timeline of FIG. 1;

FIG. 3 is a representation of a “visual inspection” workscope requirement performed in routine manner in the maintenance schedule represented in the timeline of FIG. 1;

FIG. 4 is a representation of a typical LLP stub penalty function;

FIG. 5 is a representation of a 2-stage stochastic programming framework of an optimization algorithm of the present invention; and

FIG. 6 is a representation of a gas turbine engine.

Like reference numbers and designations in the various drawings indicate like elements.

### DETAILED DESCRIPTION

An exemplary optimization algorithm(s) described herein combines stochastic programming and intelligent enumeration schemes that exploit the problem structure to avoid evaluating solutions that on their face are known to be non-optimal. The exemplary optimization algorithm(s) described herein finds the module workscope decisions and LLP replacement decisions that minimize expected future maintenance cost per engine flight cycle. The optimization algorithm considers the enormous number of possible solutions, and determines the best one. The optimization algorithm is a two-stage stochastic programming approach with an intelligent enumeration scheme that exploits the problem structure to avoid evaluating solutions that are well known to be non-optimal.

Definitions: The following definitions will be used throughout the specification.

Fleet Management Program (hereinafter “FMP”) means a program that determines what maintenance work to perform when an engine is taken off wing and sent to a maintenance facility.

Life-Limited Parts (hereinafter “LLP's”) are parts that have limited operating life, defined as having maximum number of allowable cycles.

Cycle (also commonly referred to as Flight Cycle) as used herein generally means any measured amount of engine utilization or wear, as the capabilities of the optimization algorithm described herein are not dependent upon the strict, conventional definition of a flight cycle.

Workscope Document means a document that specifies the repairs and replacements, including the workscope level of repair and replacement, to be performed on an engine and its modules during engine maintenance.

Workscope Level means a level of repair and replacement that typically falls into one of four categories: (1) inspect; (2) light; (3) medium; and (4) heavy.

“Visual Inspection” Workscope means a minimum level workscope and any workscope performed at any other workscope level satisfies this minimum level workscope.

Cycles Between Shop Visits (hereinafter “CBSV”) means the number of cycles between shop visits and constitutes a random variable due to probabilistic unscheduled engine removals (hereinafter “UER's”).

Receding Horizon Policy means a policy where only the optimal current shop visit decision is implemented and the optimal next shop visit is discarded.

Shop Visit Cost means those costs associated with an engine during a shop visit. Shop visit costs include, but are not limited to, LLP Stub Penalty cost, Module Removal cost, Module Workshop cost.

LLP Stub Penalty Cost means the cost associated with the lost opportunity from not fully utilizing the LLP up to the LLP life limit. The LLP stub penalty cost is a function of the number of cycles on the part.

Module Removal Cost means the cost associated with the material and labor associated with removing a module from an engine for any reason.

Module Workscope Cost means the cost associated with the material and labor of performing maintenance on the module to the level of the workscope.

LLP Replacement Cost means an optional cost associated with the material and labor associated with the replacement action as well as the cost of the LLP replacement part. The LLP replacement cost is optional as the cost may be covered separately under the LLP stub penalty cost and/or Module workshop cost.

Shop Visit Overhead Cost means a cost associated with miscellaneous costs such as engine transportation costs, administrative costs, etc., and other overhead costs which may differ for a scheduled engine removal as opposed to an unscheduled engine removal.

Exhaust Gas Temperature Margin (hereinafter “EGT Margin”) means a measure of an engine's overall performance health.

Scheduled Engine Removal (hereinafter “SER”) (also commonly referred to as a “shop visit”) means a shop visit that occurs when the life of an LLP reaches its limit, or the EGT margin of the engine reaches a limit.

Unscheduled Engine Removal (hereinafter “UER”) (also commonly referred to as a “shop visit”) means a shop visit that randomly occurs when some unexpected damage, failure, or event occurs. UERs are modeled using probability, that is, a failure rate, and that failure rate is referred to as the UER rate. Given a UER rate, a probability function can be computed, where this function describes the probability when a UER will occur.

Build-to Level means the number of cycles until the engine's scheduled engine removal.

Buried Flaw Limit means the constraint of the number of cycles an LLP can be used.

The optimization algorithm is a two-stage stochastic programming approach with an intelligent enumeration scheme that exploits the problem structure to avoid evaluating solutions that are well known to be non-optimal.

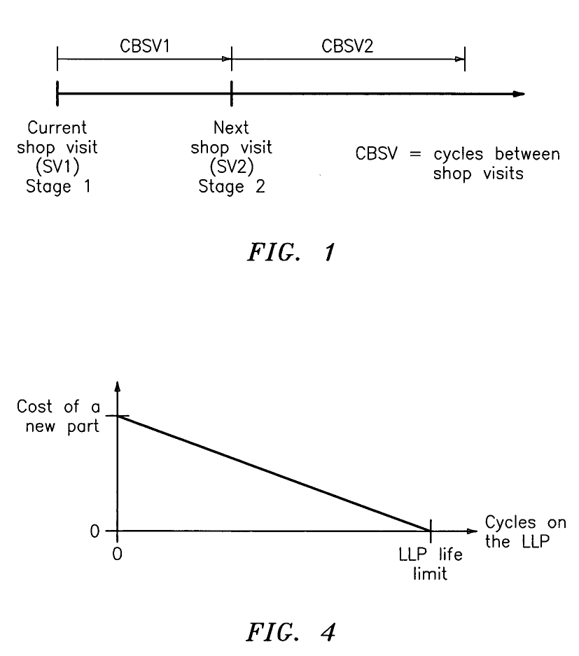

Referring now to FIGS. 1-4, a representative problem structure for a typical SER and/or UER in an FMP is shown. Referring specifically now to FIG. 1 and FIG. 6, when an engine 10 arrives at a maintenance shop, two decisions are made as follows: (1) for each LLP, whether to replace or not replace the LLP; and, (2) what is the workscope level(s) for each module? These two decisions are made for the current shop visit (hereinafter “SV1”), and the next shop visit (hereinafter “SV2”). The CBSV is a random variable due to the probabilistic UER's. The decisions are made to minimize the expected value of cost per engine flight cycle according to the following equation:

Expected value of cost per engine flight cycle=E[(Cost of SV1+Cost of SV2)/(CBSV1+CBSV2)],

where CBSV1 and CBSV2 are random variables over which the expectation is taken.

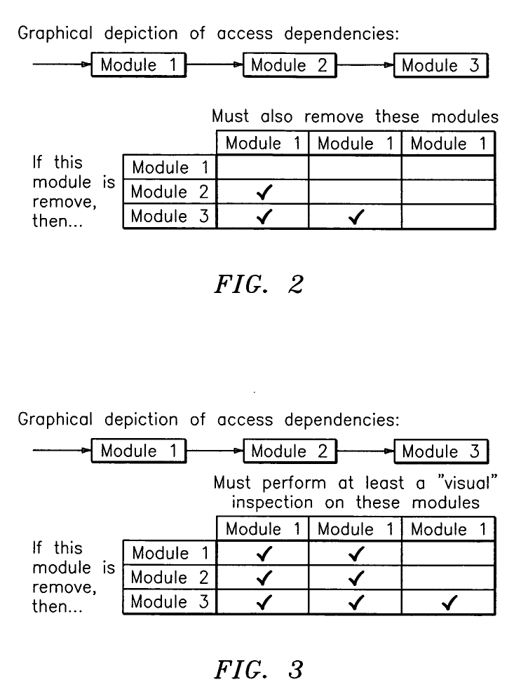

During an SV, a module may be removed from the engine in order to perform a workscope or in order to access and remove another module. Such a scenario is shown in FIG. 2. As recognized by one of ordinary skill in the art, when a module is removed, one may be required to perform at least a “visual inspection” workscope as illustrated in FIG. 3.

In constructing a problem structure that reflects a typical SER or UER of an FMP, a receding horizon policy is utilized, where only the optimal SV1 decisions are implemented, and the optimal SV2 decisions are discarded. When SV2 actually occurs, the optimization would be re-run with SV2 becoming the new SV1.

Generally, one of ordinary skill in the art of FMPs and implementing FMPs recognizes there are costs associated with each shop visit. These shop visit costs include, but not limited to, LLP stub penalty cost, module removal cost, module workshop cost, LLP replacement cost, shop visit overhead cost, and the like.

As mentioned, the stub penalty cost is a function of the number of cycles on the part, and in general can take any form. With respect to the LLP stub penalty cost, the exemplary optimization algorithm(s) assumes that the function is non- increasing. This assumption significantly reduces the computation time necessary to determine a solution. The assumption is also judged to be reasonable from a cost-benefit point of view. Generally, a linearly decreasing function is utilized, as shown in FIG. 4. However, any non-increasing function may be used as will be recognized by one of ordinary skill in the art.

Certain constraints among the decision variables are present during an SV. First, to replace an LLP, the module containing the LLP is typically be removed from the engine and undergo some level of disassembly or workscope. Each LLP has an associated minimum level of workscope that its module should undergo if that LLP is to be replaced. This minimum workscope may be different for different LLP's contained in the same module.

Second, when an engine arrives for SV1, the engine has a certain exhaust gas temperature margin (“EGT margin”), also commonly referred to as EGT0, which the engine has when it is removed from an airplane for service. Each module-workscope combination may add an EGT margin to the engine's EGT0, up to a maximum EGT as known to one of ordinary skill in the art. The resulting EGT, whether achieving the maximum EGT or not, is the EGT of the engine as the engine leaves the maintenance shop and reenters service. Once the engine reenters service, the EGT degrades. If the EGT degrades to the EGT limit, that is, before an LLP expires or a UER occurs, then the engine is removed and sent for maintenance in order to restore performance of the engine.

Third, each module of an engine has a “soft” limit measured in cycles. At the shop visit, each module has accumulated a certain number of cycles since the last heavy maintenance of that module. If this number of cycles exceeds the module's soft limit, then a “heavy maintenance” workscope level may be performed on the module.

Fourth, a minimum build-to level constraint specifies that an outgoing engine on which maintenance has been performed should have a build-to of at least the minimum build-to. The build-to of an engine that has just completed a maintenance visit is the minimum of either one of the following: (1) LLP remaining life (in cycles) of all LLP's based on the expected usage of the engine; or, (2) the number of cycles expected when the EGT margin reaches its limit.

Fifth, each LLP has a “buried flaw” limit. Typical policies call for an LLP to be replaced in the event of either one of the following: (1) an LLP has reached its buried flaw limit at the current SV; or, (2) an LLP is expected to reach its buried flaw limit at or before the next SV.

Sixth, each module has a set of feasible workscopes for SV1, which may include a heavy maintenance workscope on a module.

Lastly, for each LLP at the current shop visit, a user can enforce a decision that the LLP may be replaced or not replaced. Such decisions may also be considered a constraint.

In addition to SER SVs, there are UER SVs. UER SVs are modeled using a failure rate, which is a function that specifies the conditional probability of failure at a time or usage t, given that the machine is working up to time or usage t. A common failure rate curve may be the “bathtub” curve as is known to one of ordinary skill in the art.

In the case of LLP/workscope optimization in FMP, a UER rate (also known as the failure rate) is specified for each module, and the UER rate is a function of cycles since the last heavy maintenance performed. Any UER rate function can be specified. Given the UER rate, the probability distribution function can be computed, where the function describes the probability of when a UER will occur. The UER probabilities of the different modules are assumed to be independent as is known to one of ordinary skill in the art. Given that a UER may occur to a module, a “coincidence matrix” describes the probability of secondary damage occurring to other modules in the engine as is known to one of ordinary skill in the art.

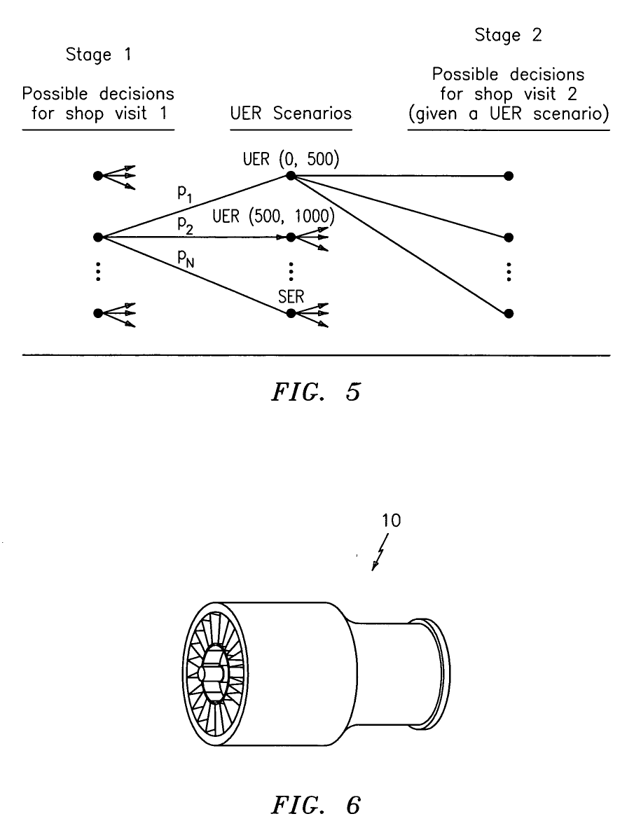

Referring now to FIGS. 1 and 5, the optimization algorithm involves making decisions at two stages as follows: (1) a decision to be made at the SV1 with uncertainty of a next shop visit or a UER; and, (2) a decision to be made at the SV2, given the decision made at Stage 1 and given the knowledge of the timing of the SV2. The knowledge of the timing of the SV2 from SV1, or CBSV1, is variable and SV2 may be a random occurrence due to a random UER. CBSV1 may also therefore be a continuous random variable.

Referring specifically now to FIG. 5, a finite set of UER scenarios may be evaluated by using discrete probabilities. Since the LLP and workscope decisions are integer valued, the optimization algorithm may enumerate each possible LLP workscope decision for SV1. For each of these enumerations, a plurality of UER scenarios is created and all possible SV2s may be evaluated. For a given shop visit 1 decision and a first UER scenario of the plurality of UER scenarios, a first optimal SV2 decision may be determined, which minimizes the expected cost per engine cycle over both Stage 1 and Stage 2. Next, for the same given SV1 decision and a next UER scenario of the plurality of UER scenarios, a second optimal SV2 decision may be determined. Each UER scenario may be evaluated in conjunction with the given SV1 decision using the optimization algorithm. The optimization algorithm may be expressed in a formula as follows:

$${\sum }_{n = 1}^{N} {P}_{n} \times E [ \frac{C 1 + C 2 * ( n )}{CBSV 1 ( n ) + CB \tilde{S} V 2 * ( n )} ] \qquad ( 1 )$$

wherein n=1,2,3 . . . ; N are the UER scenarios; C1=cost of SV1 for the given SV1 decision; C2=optimal SV2 cost for scenario n; Pₙ is the probability of scenario n; CBSV1(n)=cycles for UER scenario n; CBSV2*(n)=cycles for optimal SV2 decision; and, ˜=random variable.

Based upon the evaluations of the UER scenarios with respect to the given SV1 decision, the optimal cost per engine flight cycle may be probability weighted to produce an expected cost for the given SV1 decision. The process within the optimization algorithm may be repeated for each possible SV1 decision. The optimization algorithm of Formula (1) determines the SV1 decision exhibiting the lowest expected cost.

The optimization algorithm of Formula (1) may be formulated using equations provided after the following nomenclature tables for use in understanding the mathematical terms used herein. The purpose of the mathematical formulation is to provide one with the following: (A) an understanding of the input parameters required; (B) a set of nomenclature to use; and (C) a mathematical interpretation of the constraints previously described.

Subscripts

| | | |
|---|---|---|
| w | w = W = 4 | Workscope level. There can be any number |
| | | of workscopes, but there are 4 pre-defined ones: |
| | | w = 1 is no workscope performed, w = 2 is visual |
| | | inspection, w = 3 is module removed, and w = W |
| | | is heavy maintenance. |
| m | m = 1, 2, . . . , M | Module |
| v | v = 1, 2 | Shop visit |
| p | p = 1, 2, . . . , P | LLP |
| a | a = 1, 2, . . . , A | Assembly |

Decision Variables

| | |
|---|---|
| ω_{v,m,w} | 1 if doing workscope w to module m at visit v; 0 otherwise |
| ρ_{v,p} | 1 if replacing LLP p at visit v; 0 otherwise |

Random Variables

| | |
|---|---|
| Ūₘ(x) | The UER rate function of module m at x cycles |
| | since last shop visit, with consideration |
| | that x <= Bᵥ. |
| | ${\overline{U}}_{m} ( x ) = \{ \begin{matrix}{U}_{m} ( x + {\overline{H}}_{v , m} ) & for x < {B}_{v} \\ 0 & x \geq {B}_{v}\end{matrix}$ |
| \tilde{χ}ᵥ | Cycles flown from visit v to visit v + 1. |
| | The pdf of this random variable is based on |
| | ${\sum }_{m} {\overline{U}}_{m} ( x ) ,$ |
| | which assumes that failure rates of modules are |
| | independent. |
| Fᵥ | Flag for UER |
| \tilde{φ}_{v,m} | =1 if failure of module m at visit v, |
| | =0 otherwise |

Engine State Variables

| | |
|---|---|
| L_{v,p}⁻ | Life on LLP p at visit v induction |
| L_{v,p} | Consumed life on LLP p after visit v |
| Eᵥ⁻ | EGT margin of engine at visit v induction |
| Eᵥ | EGT margin of engine after visit v |
| H_{v,m}⁻ | Cycles since last heavy maintenance for module m at visit |
| | v induction |
| H_{v,m} | Cycles since last heavy maintenance for module m after |
| | visit v |
| H̅_{v,m}⁻ | “Effective” cycles since last heavy maintenance |
| | for module m at visit v induction, used to determine UER rate |
| | of the module |
| H̅_{v,m}⁻ | “Effective” cycles since last heavy maintenance |
| | for module m after visit v, used to determine UER |
| | rate of the module |
| Bᵥ | Build-to level of engine as a result of maintenance |
| | actions at visit v |

Input Parameters
Initial Engine State (at induction of shop visit 1)

| | |
|---|---|
| L_{1,p}⁻ | Initial life, in cycles, on part p |
| E₁⁻ | Initial EGT margin of engine |
| H_{1,m}⁻ | Initial cycles since last heavy maintenance for module m |
| H_{1,m}⁻ | Initial “effective” cycles since last heavy maintenance for module m, used to |
| | determine UER rate of the module |
| F₁ | Is current shop visit a UER? 1 = UER, 0 = SER |

Costs

| | |
|---|---|
| C_{m,w}^{ws} | Cost of performing workscope w on module m |
| Cₚ^{llp} | Cost of LLP p |
| Cₘ^{uer} | Cost of a UER for module m |
| Cₚ^{stub} (x) | Stub penalty function of LLP p as a function of cycles accumulated on the part |
| C^{uer} | Shop visit overhead cost for UER |
| C^{ser} | Shop visit overhead cost for SER |

EGT

| | |
|---|---|
| E_{m,w} | EGT margin restored by doing workscope w on module m |
| E^{max} | Maximum EGT margin for the engine |
| E^{lim} | EGT margin limit |
| D | EGT margin degradation rate |

UER's

| | |
|---|---|
| Uₘ (x) | The UER rate function of module m at x cycles since last heavy maintenance |
| X_{m1,m2} | “Coincidence matrix”: if module m1 causes the UER, the probability that module |
| | m2 will also fail. |
| I_{m,w} | The “effective” cycles since last heavy maintenance for performing workscope w |
| | on module m. For a heavy maintenance (w = W), the value is 0. For workscopes |
| | that do not affect the UER rate, a negative number flags the value of I_{m,w}. |

Workscope

| | |
|---|---|
| W_{v,m}^{min} | Minimum feasible workscope of module m at shop visit v |
| W_{m1,m2}^{min} | The minimum workscope for module m2 if module m1 has workscope >= 3 |
| W^{fail} | Minimum workscope if a module fails |
| Wₚ^{llp} | Minimum workscope for containing module m(p) when replacing LLP p |
| m(p) | module that contains LLP p |

Other

| | |
|---|---|
| Lₚ | Maximum life of LLP p |
| Rₚ | Buried flaw limit of LLP p |
| Aₐ | Set of LLP's in assembly a |
| Sₘ | Soft time limit of module m |
| B^{uer}, | Minimum build-to level for UER and SER |
| B^{ser} | |

The objective function is the expected value of cost per engine flight cycle over two shop visits as illustrated in FIG. 1 and may be expressed as Equation (1) as follows:

$$Min \{ E [ \frac{{C}_{1}^{tot} + {C}_{2}^{tot}}{{\tilde{X}}_{1} + {\tilde{X}}_{2}} ] \} \qquad ( 1 )$$

The total cost of an SV may be expressed as Equation (2) as follows:

$${C}_{υ}^{tot} = {C}^{uer} {F}_{υ} + {C}^{ser} ( 1 - {F}_{υ} ) + {\sum }_{ρ} {C}_{ρ}^{stub} ( {L}_{υ , p}^{-} ) {ρ}_{υ , ρ} + {\sum }_{ρ} {C}_{ρ}^{llp} {ρ}_{υ , ρ} {\sum }_{m} {\sum }_{w} {C}_{m , w}^{ws} {ω}_{υ , m , w} + {\sum }_{m} {C}_{m}^{uer} {\tilde{φ}}_{υ , m} \qquad ( 2 )$$

The LLP life update may be expressed as Equations (3) and (4) as follows:

L_{υ,ρ}⁻=L_{υ-1,ρ}+\tilde{X}_{υ-1} for v≧2, all ρ (3)

L_{υ,ρ}=L_{υ,ρ}⁻(1−ρ_{υ,ρ}) for all v,ρ (4)

The EGT margin update may be expressed as Equations (5) and (6) as follows:

E_{υ}⁻=E_{υ-1}−D·\tilde{X}_{υ-1} for all v≧2 (5)

$${E}_{υ} = min ( {E}_{υ}^{-} + {\sum }_{w} {\sum }_{m} {ω}_{v , m , w} {E}_{m , w} , {E}^{max} ) for all v \qquad ( 6 )$$

The module time since the last heavy maintenance update may be expressed as Equations (7) and (8) as follows:

H_{v,m}⁻= H̅_{v-1,m}+\tilde{X}ᵥ₋₁ for all v≧2, all m (7)

H_{v,m}=H_{v,m}⁻(1−ω_{v,m,W}) for all v, m (8)

The module “effective” time since the last heavy maintenance update may be expressed as Equations (9) and (10) as follows:

H̅_{v,m}⁻= H̅_{v-1,m}+\tilde{X}ᵥ₋₁ for v≧2, all m (9)

$${\overline{H}}_{v , m} = \{ \begin{matrix}{\sum }_{w} {I}_{m , w} \cdot {ω}_{v , m , w} & if {\sum }_{w} {I}_{m , w} \cdot {ω}_{v , m , w} \geq 0 \\ {\overline{H}}_{v , m}^{-} & else\end{matrix} for all v , m \qquad ( 10 )$$

The LLP life limit may be expressed as Equation (11) as follows:

L_{v,p}≦Lₚ for all v,p (11)

The buried flaw limit may be expressed as Equation (12) as follows:

Rₚ−L_{v,p}≧Bₚ for all v,p (12)

The EGT margin limit may be expressed as Equation (13) as follows:

Eᵥ≧E^{lim} for all v (13)

The soft time limit may be expressed as Equation (14) as follows:

M_{v,m}<Sₘ for all v,m (14)

The engine build-to level may be expressed as Equation (15) as follows:

Bᵥ=min└(Eᵥ−E^{lim})D,L₁−L_{υ,1},L₂−L_{v,2}, . . . ,Lₚ−L_{v,p}┘for all v (15)

The build-to level at visit v should equal or exceed the engine minimum build as expressed in Equation (16) as follows:

Bᵥ≧FᵥB^{uer}+(1−Fᵥ)B^{ser} for all v (16)

The minimum workscope may be expressed as Equation (17) as follows:

$${\sum }_{w = {W}_{v , m}^{min}}^{W} {ω}_{v . m . w} = 1 for all v , m \qquad ( 17 )$$

If an LLP is replaced, then a certain minimum workscope should be performed according to Equation(18) as follows:

$${\sum }_{w = {W}_{p}^{llp}}^{W} {ω}_{v , m ( p ) , w} \geq {ρ}_{v , p} for all v , p \qquad ( 18 )$$

The minimum workscope if a module fails may be expressed as Equation (19) as follows:

$${\sum }_{w = {W}^{fail}}^{W} {ω}_{v . m . w} \geq {\tilde{φ}}_{v , m} for all v , m \qquad ( 19 )$$

For the engine access dependencies, the minimum workscope level of module m may be expressed as Equation (20) as follows:

$${\overline{w}}_{v , m} = \begin{matrix}max \\ ∀ {m}_{2} \neq m\end{matrix} ( {W}_{{m}_{2} , m}^{min} \cdot {\sum }_{w = 3}^{W} {ω}_{v , {m}_{2} , w} ) for all v , m \qquad ( 20 )$$

The module should meet the minimum workscope level according to Equation (20), which may be expressed as Equation (21) as follows:

$${\sum }_{w = {\overline{W}}_{v , m}}^{W} {ω}_{v , m , w} = 1 for all m \qquad ( 21 )$$

A UER flag for SV2 may be expressed as Equation (22) as follows:

F₂=1 if \tilde{X}₁<B₁,=0 otherwise (22)

LLP's in the same assemblies should all be replaced together as expressed in Equation (23) as follows:

ρ_{v,i}=ρ_{v,j} for all v,a,(i,j)εAₐ (23)

The probability distribution function of \tilde{X}ᵥ may be expressed as Equations (24) and (25) as follows:

$$\begin{matrix}f ( {X}_{v} ) = \overline{U} ( {X}_{v} ) \cdot exp ( - {\int }_{0}^{{X}_{v}} \overline{U} ( t ) d t ) , & ( 24 ) \\ \overline{U} ( x ) = {\sum }_{m} {\overline{U}}_{m} ( x ) & ( 25 )\end{matrix}$$

If a UER occurs at Xᵥ, then the probability of a primary module failure may be expressed as Equation (26) as follows:

$${P}_{m}^{prim} = \frac{{\overline{U}}_{m} ( {X}_{v} )}{{\sum }_{m} {\overline{U}}_{m} ( {X}_{v} )} \qquad ( 26 )$$

The total probability of module failure given that a UER occurs, and combining both primary failure and the coincidence matrix, may be expressed as Equation (27) as follows:

$${P}_{m} = {\sum }_{i = 1}^{M} {P}_{m}^{prim} \cdot {X}_{m , i} \qquad ( 27 )$$

As mentioned, the optimization algorithm utilizes a stochastic programming approach requiring the enumeration of all possible solutions. The number of possible solutions for each SV may be expressed as 2^{P}W^{M}, where P is the number of LLP's in an engine, M is the number of modules, and W is the number of possible workscopes per module. According to the aforementioned formula, one of ordinary skill in the art recognizes the number of possible solutions grows exponentially with the number of LLP's p and modules m.

With R being the number of UER scenarios, the total number of enumerations for the 2 stage stochastic program of the optimization algorithm as shown in FIG. 5 may be expressed as follows:

Number of enumerations=2^{2P}W2mR

The typical values of these parameters are as follows: P=30; W=5; M=14; and, R=5. In an exemplary embodiment, the number of enumerations may be expressed as follows:

The number of enumerations=10³⁸,

which is an astronomical number of possible solutions that cannot be evaluated by a single individual. However, after determining the number of possible solutions, the optimization algorithm then executes an intelligent enumeration scheme utilized to avoid evaluating solutions that are known to be non- optimal.

To effectively evaluate and discard non-optimal solutions, the intelligent enumeration scheme of the optimization algorithm utilizes four (4) insights.

First, the probability distribution function \tilde{X}ᵥ is a function of the build-to level Bᵥ and a function of whether a module's workscope changes the effective cycles since last heavy maintenance, i.e., I_{m,w}≧0. This suggests grouping the solution space into groups having the same build-to level and same H̅_{v,m}. Within each group, the objective function of Equation (1) can be simplified and expressed as Equation (29) as follows:

$$Min \{ E [ \frac{{C}_{1}^{tot} + {C}_{2}^{tot}}{{\tilde{X}}_{1} + {\tilde{X}}_{2}} ] \} = Min \{ \frac{{C}_{1}^{tot} + E [ {C}_{2}^{tot} ]}{E [ {\tilde{X}}_{1} + {\tilde{X}}_{2} ]} \} , \qquad ( 29 )$$

where E└\tilde{X}₁+\tilde{X}₂┘ is a constant. Thus, for a given group, the optimization problem is reduced to the following expression as Equation (30):

Min{C₁^{tot}E└C₂^{tot}┘} (30)

Second, there exists the potential for a large number of possible build-to levels. As a consequence, there exists a large number of groups for which the need to solve the optimization problem exists. As recognized by one of ordinary skill in the art, the difference in build-to level becomes negligible for differences less than 100 to 500 cycles. Therefore, the cycles may be grouped into similar build-to levels. For example, all solutions with By in [5000, 5100] may be considered to have the same build-to level.

Third, for a given group of the same Bᵥ=bᵥ and H̅_{v,m}, by definition of Bᵥ in Equation (15) all LLP's with remaining life Lᵥ−L_{v,p}<bᵥ will have ρᵥₚ=0. For SV2, LLP's with remaining life ≧b₂ should not be replaced since replacing these LLP's will always increase E└C₂^{tot}540 (with no affect on C₁^{tot}) because of the added stub cost and new-part cost. With this insight, enumeration of LLP replacement decisions at SV2 is no longer necessary. For SV1, replacing LLP's with remaining life ≧b₁ will always increase C₁^{tot}, but it may or may not increase C₁^{tot}+E└C₂^{tot}┘. It may decrease E└C₂^{tot}┘ if it avoids having to do a higher than necessary workscope at SV2 because an LLP will have to be replaced at SV2 to make the build-to level B₂. In other words, replace the LLP at SV1 to avoid doing workscope Wₚ^{llp} at SV2. With this insight, all LLP combinations do not need to be enumerated. Instead, enumerate either none of these LLP's being replaced, or replace all of them that have remaining life <block_replace_threshold. This replace-none/replace-all enumeration has to be tried for all combinations of modules having LLP's in them.

Fourth, within each group of solutions having the same Bᵥ=bᵥ and H̅_{v,m}, and for each replacement-none/replacement-all enumeration of LLP's, there are still modules at each SV that have undecided workscopes. In order to determine these workscopes, the approach is to minimize the following component Cᵥ^{tot} in Equation (2) as expressed in Equation (31) as follows:

$${\sum }_{m} {\sum }_{w} {C}_{m , w}^{ws} {ω}_{υ , m , w} , \qquad ( 31 )$$

subject to the constraint expressed as Equation (32) as follows:

$${\sum }_{v}^{-} + {\sum }_{m} {\sum }_{w} {ω}_{v , m , w} {E}_{m , w} \geq {b}_{v} \qquad ( 32 )$$

and constraints expressed in Equations (17)- (21). This optimization problem can be solved using various techniques known to one of ordinary skill in the art.

Based upon the mathematical formulations in constructing the two stage stochastic programming framework utilized by the optimization algorithm, an optimization algorithm pseudo-code framework expressed in Formula (33) as follows:

Algorithm Psuedocode

Initialize optimal cost to a large number: Opt_cost=1e99
Loop through all build-to levels (B₁) for shop visit 1

Replace all LLP's with remaining life < B₁
Loop through all 2^{m}^{₂} combinations of those m₂ modules containing LLP's

For the current combination, set the LLP's based on replace-none/replace-all logic
Loop through all combinations of modules & workscopes that affect UER rate (i.e.

I_{m,w} ≧ 0)

For the current combination, set the workscope level of those modules
For the other modules, use Lagrangian relaxation to optimize workscopes
Initialize the cost of the current shop visit 1 enumeration: SV1_cost = 0
Compute probabilities pᵣ of all UER scenarios for the current shop visit 1

enumeration

Loop through all UER scenarios

Initialize optimal shop visit 2 cost to a large number: Opt_sv2_cost=1e99
Loop through all build-to levels (B₂) for shop visit 2

Replace all LLP's with remaining life < B₂, and keep others
Loop through all combinations of modules & workscopes that affect UER rate

For the current combination, set the workscope level of those modules
For the other modules, use Lagrangian relaxation to optimize workscopes
For the current SV1 enumeration, UER scenario, and SV2 enumeration,

$compute the cost Test\_sv2 \_cost = ( {C}_{1}^{tot} + {C}_{2}^{tot} ) \cdot E [ \frac{1}{{χ}_{1}^{uer\_scenario} + {\tilde{χ}}_{2}} ]$

If Test_sv2_cost < Opt_sv2_cost, then Opt_sv2_cost = Test_sv2_cost

End Loop

End Loop
SV1_cost = SV1_cost + pᵣ × Opt_sv2_cost

End Loop
If SV1_cost < Opt_cost, then Opt_cost = SV1_cost and save SV1 solution

End Loop

End Loop

End Loop

In the first Lagrangian relaxation step (corresponding to SV1), the workscopes are chosen to minimize the cost of SV1, which generally results in the least amount of EGT margin that meets the build-to level B1. The optimization algorithm may be implemented to achieve true optimality by enumerating the EGT margin above the value of B1. Adding EGT margins above B1 may benefit in that higher EGT margin could reduce the amount of EGT margin gain needed at SV2.

One or more embodiments described herein have been described. Nevertheless, it will be understood that various modifications may be made without departing from the spirit and scope of the invention. Accordingly, other embodiments are within the scope of the following claims.

What is claimed is:

1. A process for optimizing maintenance work schedules in a fleet management program for at least one engine, comprising:
creating at least one possible LLP workscope decision for a first shop visit for at least one engine;
creating at least one unscheduled engine repair scenario for each of said at least one possible LLP workscope decision for said first shop visit;
selecting one of said at least one unscheduled engine repair scenario for one of said at least one possible LLP workscope decision for said first shop visit;
calculating at least one expected cost for said one of said unscheduled engine repair scenario for said first shop visit;
determining a lowest expected cost of said at least one expected cost for said one of said unscheduled engine repair scenario for said first shop visit;
associating said lowest expected cost with at least one of said at least one possible LLP workscope decisions for said first shop visit;
selecting an LLP workscope decision out of said at least one possible LLP workscope decision based upon the association with said lowest expected cost for said first shop visit; and
performing upon said at least one engine said LLP workscope decision having said lowest expected cost.

2. The process of claim 1, wherein prior to the selection step of said one of said at least one unscheduled engine repair scenario further, the process further comprises:
evaluating said at least one unscheduled repair scenario according to an equation
$${\sum }_{n = 1}^{N} {P}_{n} \times E [ \frac{C 1 + C 2 * ( n )}{CBSV 1 ( n ) + CB \tilde{S} V 2 * ( n )} ]$$
wherein n=1,2,3 . . . ; N includes said at least one unscheduled engine repair scenario; C1 comprises an expected cost of said first shop visit for said at least one possible LLP workscope decision; C2 comprises an optimal cost for an unscheduled repair scenario n; Pₙ comprises the probability of scenario n; CBSV1(n) includes at least one cycle for said unscheduled engine repair scenario n; CBSV2*(n) includes at least one cycle for a possible LLP workscope decision for said unscheduled repair scenario n; and, ˜ comprises a random variable.

3. The process of claim 1, further comprising the steps of:
selecting a next unscheduled engine repair scenario for said one of said at least one possible LLP workscope decision;
calculating a next expected cost of said at least one expected cost for said next unscheduled engine repair scenario;
determining said lowest expected cost;
selecting said workscope decision having said lowest expected cost for said first shop visit; and
performing said workscope decision having said lowest expected cost upon said engine.

4. The process of claim 1, wherein the calculation step of said at least one expected cost comprises the following steps:
calculating at least one optimal cost per engine flight cycle for all of said at least one unscheduled engine repair scenario with respect to each of said at least one workscope decision; and
generating said at least one expected cost based upon said at least one optimal cost per engine flight cycle.

5. The process of claim 1, wherein the determination step of said lowest expected cost comprises the steps of:
comparing all of said at least one expected cost with each other; and
selecting said lowest expected cost of all of said at least one expected cost.

6. The process of claim 1, further comprising the following steps:
enumerating at least one possible solution comprising at least one optimal LLP workscope decision or at least one non- optimal LLP workscope decision;
applying at least one of four insights to identify said at least one non-optimal LLP workscope decision;
identifying said at least one non-optimal LLP workscope decision as a non-optimal solution; and
identifying said at least one optimal LLP workscope decision as an optimal solution;
wherein said at least one optimal LLP workscope decision is said workscope decision having said lowest expected cost.

7. A process for optimizing maintenance work schedules in a fleet management program for at least one engine, comprising:
creating at least one possible LLP workscope decision for a first shop visit for at least one engine;
creating at least one unscheduled engine repair scenario for each of said at least one possible LLP workscope decision for said at least one engine;
evaluating said at least one unscheduled repair scenario according to an equation
$${\sum }_{n = 1}^{N} {P}_{n} \times E [ \frac{C 1 + C 2 * ( n )}{CBSV 1 ( n ) + CB \tilde{S} V 2 * ( n )} ]$$
wherein n=1,2,3 . . . ; N includes said at least one unscheduled engine repair scenario; C1 comprises an expected cost of said first shop visit for said at least one possible LLP workscope decision; C2 comprises an optimal cost for an unscheduled repair scenario n; Pₙ comprises the probability of scenario n; CBSV1(n) includes at least one cycle for said unscheduled engine repair scenario n; CBSV2*(n) includes at least one cycle for a possible LLP workscope decision for said unscheduled repair scenario n; and, ˜ comprises a random variable;
selecting one of said at least one unscheduled engine repair scenario for one of said at least one possible LLP workscope decision for said first shop visit;
calculating at least one expected cost for said one of said unscheduled engine repair scenario for said first shop visit;
enumerating at least one possible solution for said one of said unscheduled engine repair scenario, said at least one possible solution comprising at least one optimal LLP workscope decision or at least one non-optimal LLP workscope decision;
applying at least one of four insights to identify said at least one non-optimal LLP workscope decision out of said at least one possible solution;
identifying out of said at least one possible solution a non-optimal solution based upon said at least one of four insights, said non-optimal solution comprising at least one non- optimal LLP workscope decision;
identifying out of said at least one possible solution an optimal solution based upon said at least one of four insights and associated with a lowest expected cost out of all of said at least one expected cost, said optimal solution comprising said at least one optimal LLP workscope decision having said lowest expected cost out of all of said at least one expected cost; and
performing upon said at least one engine said at least one optimal LLP workscope decision having said lowest expected cost.

8. A system comprising a computer readable storage device readable by the system, tangibly embodying a program having a set of instructions executable by the system to perform the following steps for optimizing maintenance work schedules of a fleet management program for at least one engine, the set of instructions comprising:
an instruction to create at least one possible LLP workscope decision for a first shop visit for at least one engine;
an instruction to create at least one unscheduled engine repair scenario for each of said at least one possible LLP workscope decision for said first shop visit;
an instruction to select one of said at least one unscheduled engine repair scenario for one of said at least one possible workscope decision for said first shop visit;
an instruction to calculate at least one expected cost for said one of said unscheduled engine repair scenario for said first shop visit;
an instruction to determine a lowest expected cost of said at least one expected cost for said one of said unscheduled engine repair scenario for said first shop visit;
an instruction to associate said lowest expected cost with at least one of said at least one possible LLP workscope decision for said first shop visit;
an instruction to select an LLP workscope decision out of said at least one possible LLP workscope decision based upon the association with said lowest expected cost for said first shop visit; and
an instruction to perform said LLP workscope decision having said lowest expected cost upon said at least one engine.

9. The system of claim 8, wherein prior to the instruction to select said one of said at least one unscheduled engine repair scenario, the set of instructions further comprises:
an instruction to evaluate said at least one unscheduled repair scenario according to an equation
$${\sum }_{n = 1}^{N} {P}_{n} \times E [ \frac{C 1 + C 2 * ( n )}{CBSV 1 ( n ) + CB \tilde{S} V 2 * ( n )} ]$$
wherein n=1,2,3 . . . ; N includes said at least one unscheduled engine repair scenario; C1 comprises an expected cost of said first shop visit for said at least one possible LLP workscope decision; C2 comprises an optimal cost for an unscheduled repair scenario n; Pₙ comprises the probability of scenario n; CBSV1(n) includes at least one cycle for said unscheduled engine repair scenario n; CBSV2*(n) includes at least one cycle for a possible LLP workscope decision for said unscheduled repair scenario n; and, ˜ comprises a random variable.

10. The system of claim 8, further comprising the following instructions:
an instruction to select a next unscheduled engine repair scenario for said one of said at least one possible LLP workscope decision;
an instruction to calculate a next expected cost of said at least one expected cost for said next unscheduled engine repair scenario;
an instruction to determine said lowest expected cost;
an instruction to select said workscope decision having said lowest expected cost for said first shop visit; and
an instruction to perform said workscope decision having said lowest expected cost upon said engine.

11. The system of claim 8, wherein the instruction to calculate said at least one expected cost comprises the following instructions:
calculating at least one optimal cost per engine flight cycle for all of said at least one unscheduled engine repair scenario with respect to each of said at least one workscope decision; and
generating said at least one expected cost based upon said at least one optimal cost per engine flight cycle.

12. The system of claim 8, wherein the instruction to determine said lowest expected cost comprises the following instructions:
an instruction to compare all of said at least one expected cost with each other; and
an instruction to select said lowest expected cost of all of said at least one expected cost.

13. The system of claim 8, further comprising the following instructions:
an instruction to enumerate at least one possible solution comprising at least one optimal LLP workscope decision or at least one non-optimal LLP workscope decision;
an instruction to apply at least one of four insights to identify said at least one non-optimal LLP workscope decision;
an instruction to identify said at least one non-optimal LLP workscope decision as a non-optimal solution; and
an instruction to identify said at least one optimal LLP workscope decision as an optimal solution;
wherein said at least one optimal LLP workscope decision is said workscope decision having said lowest expected cost.

14. A system comprising a computer readable storage device readable by the system, tangibly embodying a program having a set of instructions executable by the system to perform the following steps for optimizing maintenance work schedules of a fleet management program for at least one engine, the set of instructions comprising:
an instruction to create at least one possible LLP workscope decision for a first shop visit for at least one engine;
an instruction to create at least one unscheduled engine repair scenario for each of said at least one possible LLP workscope decision for at least one engine;
an instruction to evaluate said at least one unscheduled repair scenario according to an equation
$${\sum }_{n = 1}^{N} {P}_{n} \times E [ \frac{C 1 + C 2 * ( n )}{CBSV 1 ( n ) + CB \tilde{S} V 2 * ( n )} ]$$
wherein n=1,2,3 . . . ; N includes said at least one unscheduled engine repair scenario; C1 comprises an expected cost of said first shop visit for said at least one possible LLP workscope decision; C2 comprises an optimal cost for an unscheduled repair scenario n; Pₙ comprises the probability of scenario n; CBSV1(n) includes at least one cycle for said unscheduled engine repair scenario n; CBSV2*(n) includes at least one cycle for a possible LLP workscope decision for said unscheduled repair scenario n; and, ˜ comprises a random variable;
an instruction to select one of said at least one unscheduled engine repair scenario for one of said at least one possible LLP workscope decision for said first shop visit;
an instruction to calculate at least one expected cost for said one of said unscheduled engine repair scenario for said first shop visit;
an instruction to enumerate at least one possible solution for said one of said unscheduled engine repair scenario, said at least one possible solution comprising at least one optimal LLP workscope decision or at least one non-optimal LLP workscope decision;
an instruction to apply at least one of four insights to identify said at least one non-optimal LLP workscope decision out of said at least one possible solution;
an instruction to identify out of said at least one possible solution a non-optimal solution based upon said at least one of four insights, said non-optimal solution comprising at least one non-optimal LLP workscope decision;
an instruction to identify out of said at least one possible solution an optimal solution based upon said at least one of four insights and associated with a lowest expected cost out of all of said at least one expected cost, said optimal solution, said optimal solution comprising said at least one optimal LLP workscope decision having a lowest expected cost of all of said at least one expected cost; and
an instruction to perform said at least one optimal LLP workscope decision having said lowest expected cost upon said at least one engine.
